(19) United States
(12) Patent Application Publication
(10) Pub. No.: US 2012/0130742 A1
(43) Pub. Date: May 24, 2012

(54) Advanced Electronic Communication Method and System for an Established Doctor-Patient Relationship

(76) Inventors: Frederick A. Church, Lenexa, KS (US); Gareth B. Roblin, Mount Colah (AU)

(21) Appl. No.: 12/954,324

(22) Filed: Nov. 24, 2010

(51) Int. Cl. G06Q 50/00

(52) U.S. Cl. 705/3

(57) ABSTRACT

A method and system is provided to enable an internet-based, advanced, electronic communication service between an established patient, already in a previously established doctor-patient relationship, and his/her doctor(s) to facilitate participation in an electronic consultation via an electronic communication connection. The method and system includes initiating connection with a central computer by the patient- and doctor-users; collecting and recording user entered information; creating a unique identifier for each user; and registering the user; collecting and recording medical record information for the patient-user from the doctor-user; creating an electronic relationship between the doctor-user and patient-user; validating the relationship; if said validating step is true, then: opening an electronic connection between the doctor-user, patient-user and computer; transferring question data from the patient-user to the doctor-user through the computer and transferring answer data from the doctor-user back to the patient-user through the computer; and storing the data on the computer.

### FIELD

A method and system for an advanced electronic communications system may be directed to electronically connecting known, established patients with their known, established doctors facilitating e-Consultations/e-Consults.

### BACKGROUND

Over the course of medical history in modern times, multiple systems have been developed to facilitate consumers of healthcare (aka patient or patients) and various healthcare service providers (physicians, nurses, mid-level healthcare providers [PAs/ARNPs]). Based on patient desire for healthcare services, the marketplace has created available “on-demand,” optional healthcare advice systems (e.g., optional “Ask-A-Nurse” telephone services and a multitude of optional internet-based information sources, e.g., “medineplus.gov”, “Mayoclinic.com”, “WebMD”, etc.). Having a myriad of available avenues of healthcare information has proven helpful to both afflicted and unafflicted patients alike. This information has helped them to gain perspective and different opinions about varying treatment options and preventative measures to affect an individual patient's optimal health potential. The ability for patients to independently obtain information from various sources has allowed patients to access information about potential options, but at the cost of informational overload and personal application confusion.

It may be well-known by patients and healthcare service providers alike that information alone may be not adequate to affect optimal patient health. Patients can learn a plethora of information about their respective ailments and medical conditions, but applying the information best to their particular problems or concerns has always been best implemented with the consultation of and within an established, nurturing relationship between an individual patient and their respective physician(s). When an individual patient self-determines to apply medical information to affect their health, undesired detrimental consequences to their health can and have occurred. In like manner, misapplication of sound medical advice from healthcare service providers has contributed to similar undesired consequences to a patient's health.

In accordance with well-known and respected medical practice, patients regularly seek medical examination and advice from licensed healthcare service providers in their respective locales/settings. Individualized advice and opinions obtained from a healthcare service provider/consultant who may be licensed to provide independent information are a valuable resource to patients who seek optimal health and personalized healthcare delivery. In keeping with sound medical practice, it may be common place today that patients are evaluated in person and by physical examination by a licensed healthcare service provider in their respective locales. Most of the time, an individual patient may be routinely evaluated in person by physical examination by a healthcare service provider and, thereby, able to obtain personalized medical advice via direct communication interaction. Those services are typically conducted during daylight business hours.

Patients can and often request healthcare services in time-frames different than what their established, personal healthcare service provider of choice has business hours or availability. It may be commonly accepted that no individual human doctor/physician can be available 24/7/365 for his/her patients and serve their needs continuously and “on demand.” Thus, doctors are reluctant to provide their direct contact paths (mobile-phone numbers and email) to their patients due to concern of over utilization and inability to disengage.

Patients play an active role in self-determining the urgency/emergency of their particular medical problems or concerns and make decisions based on their available options. While marketplace forces have created options for them, there are considerable deficiencies and inefficiencies of service delivery as well as marketplace forces (insurance, employers' restrictions) that sometimes impede the implementation of optimal, cost-effective, and patient-satisfying healthcare delivery to an individual patient.

Based on patients' desire for healthcare services, the marketplace has created after-hour delivery services for patients to be examined, assessed/evaluated, and healthcare treatment services rendered (e.g., Emergency Departments at hospitals and Urgent Care facilities). When an individual patient deems the before-mentioned services are not necessary for their particular medical problem, there are marketplace options for patients to seek medical advice from a healthcare service provider/consultant (e.g., Ask-A-Nurse) in determining need and urgency for an assessment by a healthcare service provider. Sometimes, an individual patient desires to seek advice from a healthcare service provider/consultant who may be not previously known by them or, likewise, the healthcare service consultant does not have a previously established relationship with the patient.

The marketplace has responded to an individual patient's desire for after-hour electronic consultation (aka e-consult) services with licensed healthcare service providers whom he/she previously did not have an established relationship. Many times, an individual patient may desire to communicate with his/her known, established, and trusted doctor for advice, but due to social norms of acceptable access beyond normal daylight business working hours, are unable to access the consulting advice of their personal, established doctor during a time-frame that may be most desirable for the patient. Additionally, not all patients or doctors may have equipment (computer or smartphone) or desire to participate in an e-consult communication modality.

In keeping with sound medical practice, it may be common place today that an individual patient may be best assessed and evaluated based on physical knowledge of the patient within the scope of a universally recognized, established doctor-patient or physician-patient relationship. To quote the AMA regarding the sanctity of this established relationship principle:
“The patient-physician relationship may be of greatest benefit to patients when they bring medical problems to the attention of their physicians in a timely fashion, provide information about their medical condition to the best of their ability, and work with their physicians in a mutually respectful alliance.”

While beyond the scope of this work, an established doctor-patient relationship may be described to include, but may be not exclusive to, current or prior knowledge obtained from a medical history given by an individually known patient (preferably firsthand when feasibly possible and as best known by the patient regarding their available and known medical information), gathering medical data/information by physical examination and current history of known patient, and providing an assessment/evaluation including medical advice to known patient based on the medical knowledge and judgment gathered by a patient's known doctor.

Whereas the most common understanding of the “doctor-patient” or “physician-patient” relationship encompasses a specific individual patient and their preferred and trusted physician (M.D. or D.O.), the disclosed may refer to the “doctor” and “patient” to encompass and apply to any professional relationship between a voluntary act of any individual, established patient seeking remunerated services from their appropriately licensed and established doctor of choice of the same locale in a permitted jurisdiction regardless and superseding any type of insurance carrier or third party payer participating in the relationship. Statutes of various locales of jurisdiction (e.g., states) may vary on the scope of allowable services to be rendered during an e-consult and in keeping with local norms of standard good medical practice. Remunerated doctors should be individually responsible and aware of the statutes that govern the scope of e-consults in their respective locales as it pertains to individual arrangements they may make with their respective patient.

The doctor-patient relationship may be enhanced and preserved by providing a process that may allow optional electronic connection (e-connect) access by established patients directly to their established, remunerated doctor via e-consults. By providing a technological process that maintains maximal portability of connectivity and service flexibility for facilitating volitional e-consults, enhanced communication between both a known, established patient and their known doctor(s) may be achieved. At present, there may be significant risk of further fragmentation of the current doctor-patient relationship in a delivery system of healthcare that has increasing pressures of expense, various inefficiencies of delivery and payment, and apathy and burnout by both patient(s) and doctor(s). Because of these forces, the potential for greater fragmentation and poor patient outcomes may be present. The disclosed method and system may provide opportunity for marketplace forces to create greater optional, after-hour access obtained by an individual patient from their doctor(s) of choice thereby allowing the potential for enhanced optional communication via e-consultations. These e-consults and communication enhancements may result in lower long-term costs and improved health outcomes.

### SUMMARY

In general, a method and system may be disclosed to enable an internet-based, advanced, electronic communication service between an established patient, already in a previously established doctor-patient relationship, and his/her doctor(s) to facilitate participation in an optional, electronic consultation (e-consult) via an electronic communication connection (e-connect).

The electronic communication connection may require an internet-based computer (or a network of computers; such as a website) which hosts, maintains, and manages a platform for advanced communication options. The website may facilitate an e-connection between users, namely doctor(s) and their established patient(s), for example, via encrypted database management and storage of users' information. The internet services provided, commonly referred to as “internet software as a service” (SaaS), facilitates the registration, connection, payment exchange and communications between doctor-users and their established patient-users. The service provided may be an electronic consulting (e-consulting) platform that doctors and their established patients can utilize for consulting engagements. Various technological security methods may be employed to ensure the communications and personal data are secured. Security mechanisms may include, but are not limited to, user identification and authentication, network transport encryption and message authentication, data and database encryption. Users may connect to the service via a plurality of internet enabled devices including personal computers, handheld and portable computers, mobile telephones, smartphones or any internet connectivity device that may be capable of secure network communications, for example.

Implementations may include one or more of the following features: verifying the identity of a doctor-user; verifying the identity of a patient-user; establishing the e-connection relationship between established doctor-patient users; e-consult process; and/or auxiliary database CRM options and services.

Verifying the identity of a doctor-user: A registration and validation process may exist to validate the credentials provided by the doctor (aka doctor-user) and, in good faith, confirm the identity of doctor-user in order to prevent fraudulent representations of the doctor-user. Once the doctor-user's credentials and details are confirmed, the application software service may be enabled for the doctor-user. The doctor-user may be then empowered to establish an electronic consulting presence and establish connections with known patients (aka patient-users). The doctor-user may confirm the identity of their established patient-users and, in good faith, affirm the establishment of a valid, mutually voluntary e-connection relationship (e-relationship) of established users.

Additionally, a doctor-user needs to establish a supported financial accounting service in order to receive fees collected for consultations (e.g., a PayPal account). The account details should be provided to the software system in order for the doctor-user to receive payments for e-consultations. All users, both doctor-user and patient-users should be uniquely identified and authenticated before being permitted access to the internet service.

Verifying the identity of a patient-user: A registration and validation process may exist to validate the identity provided by the patient (aka patient-user) and, in good faith, confirm the identity of patient-user in order to prevent fraudulent representations of the patient-user. Once the patient-user's identity and details are confirmed, the application software service may be enabled for the patient-user. The patient-user may then be empowered to establish an electronic consulting presence and establish connections with known, established doctors (aka doctor-users). The patient-user may confirm the identity of their established doctor-users and, in good faith, affirm the establishment of a valid, mutually voluntary e-connection relationship (e-relationship) of established users. As part of the registration process, the patient-user may enter his personal health information that may include, for example, information regarding the medications the patient-user is taking or his known past medical information.

Additionally, a patient-user needs to establish a supported financial accounting service in order to remunerate fees collected for e-consultations (e.g., a PayPal account). The account details should be provided to the software system in order for the patient-user to make payments for e-consultations. All users, both doctor-user and patient-users should be uniquely identified and authenticated before being permitted access to the interne service.

Establishing the e-connection relationship between established doctor-patient users: A validation process may be established to validate the identity of a patient-user and, in good faith, confirm the identity of his/her established doctor-user and, in reciprocation, the doctor-user to confirm the identity of his/her established patient. A validation process may be established in order to affirm an authorized, mutually-confirmed e-connection relationship of established users. The validation process may be intended to prevent fraudulent e-connection interaction and detrimental communication consequences from unauthorized users. The validation process may also include the doctor-user verifying the medications prescribed to the patient-user by the doctor-user.

E-consult process: In general, and in one aspect, a question may be securely communicated from an established patient-user to their doctor-user(s). A submitted question may be also an implied request to the doctor-user to participate in an electronic consultation (e-consult). A doctor-user can accept, decline, ask for clarification, or defer the electronic consultation request as they see fit. The patient-user question may be entered to the website via a written and readable typed text format or an uploaded audio or audio-video file format. The doctor-user may receive a notification when an e-consult question/request from their established patient-user may be available for previewing. The doctor-user may preview and answer the question via information documented in a written and readable typed text format or an uploaded audio or audio-video file format. The application software stores the securely uploaded question response data from the doctor-user and notifies the patient-user of the available answer to preview. The patient-user securely reestablishes e-connection to the website and has the ability to access the answer in a HIPAA-compliant manner.

In general, in one aspect, a request may be received from a patient-user for an on-demand, real-time optional consultation with their personal, known doctor-user(s). The website may monitor a doctor-user's availability status and seek to facilitate additional e-consult options via industry-standard formats: live chat and/or audio or audio-video teleconferencing.

Auxiliary database Customer Relation Management (“CRM”) options and services: In general, in one aspect, a doctor-user may desire to send a specific or general communication directive(s) to any or all his/her established patient-user(s) for enhanced communication efficiency to enhance their relationship via the optional e-connection. The website may facilitate the distribution of a transactional singular or multiple communication directive(s) from a specific doctor-user and their established, e-connected patient-user(s). The common communication information data may be securely entered to the website via a written and readable typed text format or an uploaded audio or audio-video file format.

The website may prompt users (patient-users and doctor-users) for optional participation in additional third party information database CRM services and products in exchange for remuneration or lower transactional cost structure for future e-consultations.

The disclosed regularly refers to doctor-patient consultation communications via electronic mediums (interne, smartphones, etc.). Unless otherwise stated, in any such reference to electronic communications between doctor-users and patient-users, it should be assumed that the communication modes may be textual, auditory (uploaded audio files, online voice communications), visual (uploaded photos and/or video and/or online video conferencing) or a mixture of the modes.

### BRIEF DESCRIPTION OF THE FIGURES

FIG. 1 is a diagram of the e-connection communication system.

FIG. 2 is a diagrammatic view of an e-connection relationship.

### DETAILED DESCRIPTION

As required, detailed embodiments of the present invention are disclosed herein. However, it may be to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated may be generally preferred. Also, unless expressly stated to the contrary, the description of a group or class of materials as suitable or preferred for a given purpose in connection with the invention implies that mixtures or combinations of any two or more members of the group or class may be equally suitable or preferred.

The method and system described below provides an integrated information and communications system via a secured electronic connection to a website's computer(s)/server(s) that enables a patient-user to identify and e-connect with his/her established, known doctor-user(s) with whom he/she may engage in optional e-consult communication modalities in an efficient manner, even when the two users are geographically separated. The website may utilize internet services (commonly referred to as “internet software as a service (SaaS)”) application software.

The website computer(s)/server(s) (website) may securely store in an encrypted process the unique data identifiers of both the patient-user(s) and doctor-user(s). For patient-users, the unique and current data identifiers may include full name, home address, home telephone number, date of birth, doctor-user'(s) name(s), electronic payment method, email, mobile phone number and company name of mobile phone carrier service, email address, picture of patient-user, and log-in user ID and password, for example. For doctor-user(s), the unique and current data identifiers may include full name, office address, office telephone number, office manager, date of birth, board certification, and other unique private doctor identifiers (e.g., DEA number, UPI/NPI number, state license number(s), etc.), electronic payment receipt method, email address, pager number, mobile phone number and company name of mobile phone carrier service, picture of doctor-user, and log-in user ID and password, for example.

Patient-user(s) may be able to e-consult with their personal doctor-user(s) at any time of the day (24/7/365) by securely accessing the website and submitting their remunerated question to their preferred doctor-user of choice and, preferably, within a time-frame that may be mutually agreed upon. The website may store the patient-user's question data until the doctor-user may be available to preview and respond to the question request. Additionally, and if both parties consent, the website may match available parties (e.g., one patient-user with one doctor-user) to participate in a real-time, on-demand e-consultation using remunerative industry-recognized formats: live chat and/or audio-video teleconferencing, for example. The website maintains security and permits only authorized access to e-consultation information/data (both answer and question) to preserve privacy of electronic patient health information (“PHI”) in a HIPAA-compliant manner.

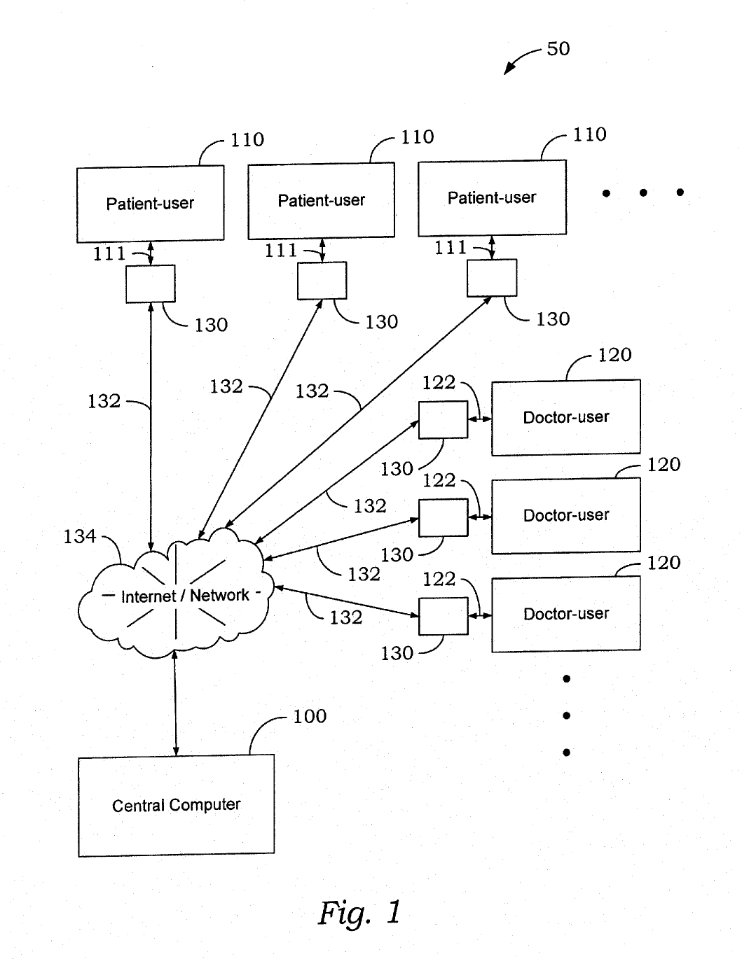

FIG. 1 is an illustration of an e-connection relationship 50 (“e-relationship”). The communications system may include a website (a computer/server or a network of computers or servers) 100 for making e-connections between patient-user(s) 110, via a connection 111 to an internet connectivity device 130, and doctor-user(s) 120, via a connection 122 to an internet connectivity device 130, each of the internet connectivity devices 130 connected 132 to a network 134, e.g., the Internet or other types of networks. The website 100 may operate as a service running on a website's computer(s)/server(s). The website 100 may include an availability or presence tracking module for tracking the “e-Connect Now” availability of an individual doctor-user and patient-user.

Individual doctor-user and patient-user availability status or presence may be monitored actively and passively. In an active status, a doctor-user may indicate his availability to the website and that the individual doctor-user may be available and willing to be contacted by his known, established patient-user(s) and vise versa. Additionally, there may be a capacity to indicate the type of communication mode by which the doctor-user or patient-user may be contacted.

In an example of an active availability status monitoring, the individual doctor-user's internet connectivity device periodically provides an indication of the doctor-user status regarding his/her availability (e.g., available, online, idle, busy) to the website and a communication mode (e.g., text, audio, or audio-video, etc.) by which the doctor-user or patient-user may be engaged during an e-connection e-consult. In an example of passive status monitoring, the website presumes that the doctor-user (or patient-user) may be available by the doctor-user's (or patient-user's) current status being connected to the website. Furthermore, the website indicates the passive availability status of the doctor-user (or patient-user) until the doctor-user (or patient-user) logs off the secure e-connection, except when the doctor-user may be actively participating in an e-consult with another patient-user (or doctor-user).

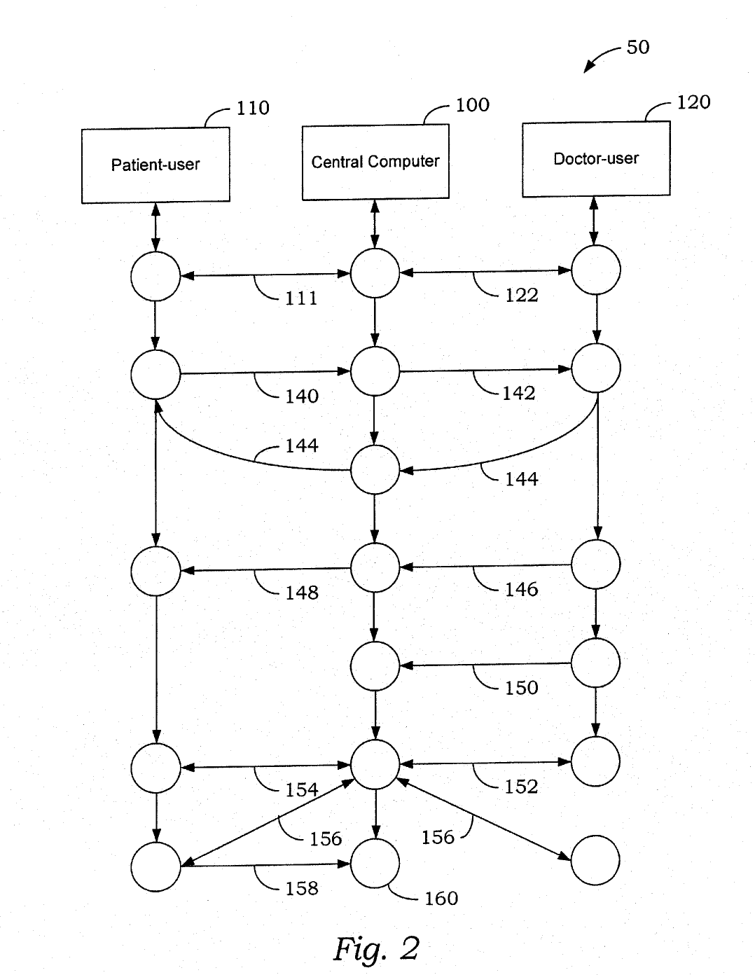

Referring to FIG. 2, both users, doctor-users and patient-users, may be securely registered with the website and provide requested personal unique identifiers via website's webpage forms. An individual patient-user may be allowed to be an individual family's representative when the patient involved in the question may be a minor and may not legally represent themselves in this e-consult model and, instead, the family's representative, such as the legal parent or guardian, may best represent the patient involved in the question and assume the responsibilities of the patient-user for payment and implementation of the information to the minor. Every legal adult over the age of 18 may have his/her own individual patient-user identity.

The patient-user provides unique identifiers and only for previously established doctor-patient relationship, such as picture, name, dob, address, etc, for example. The patient-user agrees to terms of optional website service and sets up a third party payment option, such as PayPal. The patient-user sets option for single transaction question or prepaid plan of a set number of questions 111.

Doctor-users may undergo a vigorous validation process to authenticate the accuracy of their submitted information with due diligence and confirmation with known third-party database information. At the time of registration, doctor-users may establish their adjustable preferences regarding their status modes that the website may track, such as: 1) a question response time-frame—a “QRT” status; 2) an “e-Connect Now” availability status for enhanced e-connected communication options; and 3) a “do not disturb” status. Fewer or more status modes may be included to provide a simpler interface or provide more detailed information, for example.

The doctor-user provides unique identifiers (e.g., picture included, etc.) and website service verifies authenticity; the doctor-user agrees to terms of website service. The doctor-user sets up initial consult fees for both single transaction and prepaid options. The doctor-user sets up initial QRT status of their question response time to patient-user questions, “e-Connect Now” availability status for direct e-consults, and “do not disturb” parameters, for example. The doctor-user sets up third party payment receipt option, such as PayPal 122.

The website application software prompts both parties to recognize each other to confirm e-relationship before payment for question consultation is initiated. The doctor recognition may first be initiated by the patient-user searching for a doctor-user's name in website database on the server(s) and verified by the patient-user based on his/her uploaded picture to the website. The patient-user recognition may be confirmed by an established patient-user seeking a doctor-user to establish e-relationship after the patient-user registers and prompts request for relationship establishment with the doctor-user. The doctor-user then confirms his/her patient's picture visually and known unique identifiers.

Once the website has confirmed the individual doctor-user and patient-user information, the users may be allowed to confirm each other's identity and establish an e-connection relationship. As a part of the initial registration process, the website may confirm e-connections with the patient-user's unique addresses for their internet-connectivity devices (e.g., mobile phone numbers for SMS text receipt and email addresses). If the validation process for affirming authenticity of an individual patient's submitted contact information regarding his personal internet connectivity devices may not be confirmed or the internet connectivity device's corresponding internet service connection remains blocked from receiving data from the website, the capacity to participate in e-connect communications from website may be disengaged. The website may provide aid to patient-users and doctor-users through troubleshooting the problem and/or an individual user may require the assistance of his individual ISP or mobile phone carrier service to permit e-connection data exchange with the website.

Both users, the doctor-user and the patient-user, may be registered with the website and may be prompted by the website to confirm the identity of the other user in a mutually confirmed and voluntary manner. The website may allow patient-users to perform name searches for their desired doctor-user(s) to evaluate if they are appropriately registered and available for an e-relationship establishment and e-consults.

The website may allow the doctor-user to confirm the individual patient-user's unique identifiers. The doctor-user may also affirm the identity of the unique patient-user as their established patient by the individual patient's visual picture (or pictures if representing other family members who are minors) uploaded by the patient-user in accordance with website protocol. In like manner, the website may allow the patient-user to confirm the individual doctor-user's full name, office address and telephone number, and the individual doctor-user's uploaded visual picture in accordance with website protocol.

If there are concerns regarding an individual user (either patient-user or doctor-user) conducting in fraudulent activity or misrepresentation of the previously confirmed user's identity, the website may have a process to reevaluate the authenticity of the user in question and possibly disallow the user from future participation if fraudulent activity has occurred. If an individual user (either doctor-user or patient-user) desires to disconnect an established e-connection relationship, the e-connection relationship (e-relationship) may be terminated or removed from the website.

An individual patient-user may have payment options including but not limited to the following options: singular transactional and pre-paid multiple e-consult packages. An individual patient-user should be of legal, independent decision-making age which may be commonly accepted as 18 years of age. The primary type of singular transactional e-consult questions may consist of one of a variety of formats: text-based or an uploaded audio file or audio-video file. The website may prompt the patient-user in the process to enter the text directly into the website's webpage form, or upload a pre-prepared audio or audio-video file to the website server. The website stores the securely uploaded question data from the patient-user and documents the receipt of the question and assigns a unique transaction reference number along with a time and date stamp. The patient-user may reference the website's posting of his doctor-user's status, such as QRT status, “e-Connect Now” availability status, and “do not disturb” status, for example, prior to submitting a question and in accordance with his individual self-determined concern about his healthcare need's urgency.

The website may maintain one or more audit logs containing time and date stamps relevant of every step in the e-connection communication interaction that may be managed via the software service. The application software that supports the website and communications may be the primary reference source of confirmatory time and dated communications and not based on any outsourced reference (e.g., an individual interne connectivity device's unique time and date).

Once the receipt of the patient-user's question has been submitted 140 and confirmed as received, the website proceeds to send a time and dated notification to the doctor-user of the available question to preview 142. The content and method of the notification may include sending a HIPAA-compliant, non-specific prompt to the doctor-user to securely login (aka e-connecting) to the website. The notification may be communicated to doctor-user via one or many mechanisms and may be dependent of the doctor-user's preferences: SMS text message, email, online prompt (if currently logged in) or via securely connected, application specific client software (e.g., smartphone e-connect client software).

Once the receipt of the patient-user's question has been submitted and confirmed as received, the website proceeds to send a time and dated notification to the doctor-user of the available question to preview 142. The content and method of the notification may include sending a HIPAA-compliant, non-specific prompt to the doctor-user to securely login to the website via a SMS message automatically generated to the doctor-user's internet connectivity device of preference, such as a smartphone, for example, routed via a unique internet address gateway data communication, such as a text message or custom application specific client software on the user's internet connected device (e.g., smartphone e-connect client software).

Once the doctor-user establishes a secure connection with the website, the patient-user's question may be reviewed. A registered patient-user submits a question for engagement with their known doctor based on their self-assessment of urgency and their doctor's availability statuses and “do not disturb” parameters. The doctor-user's “QRT” (question response time) status is a term used to describe what time-frame response the doctor-user anticipates being able to respond to a question. For example, the doctor-user may list his or her QRT status as “within 1-4 hours,” “within 4-12 hours,” “within 12-24 hours,” “within 1-3 days,” “within 4-7 days,” “within 1-2 weeks,” or “unavailable until further notice,” for example 150. This may be adjustable at any time when the doctor-user logs in and changes his/her status or is prompted. The doctor-user's “do not disturb” status allows for doctor-users to not be disturbed during certain adjustable time periods. For example, a doctor-user may set as a routine “do not disturb” parameter when he or she is sleeping between 11 p.m.-6:30 a.m. every day of the week except Mondays when he or she is on call.

At this point, the website may prompt the patient-user to agree to submit payment coinciding with question initiation process. The website's application software time and date stamps the question submitted. The question/answer interaction may be freely available for a predetermined period of time such as 30 days, for example, and may be removed after another period of time, such as 90 days, for example. The doctor-user may have the option to reply via the website user interface by directly entering a textual reply or by uploading a previously recorded audio or audio-video file to the website server or decline the question 144. Declining the question may involve standardized responses 146, such as “Inappropriate—you need to seek medical attention immediately;” “Please consider your present health concern as life-threatening or emergent or urgent and take appropriate action;” “Inadequate information/Need clarification of question;” “Decline at this time;” “This question/issue needs evaluation in person directly—Please call to setup an appointment;” or “Other,” for example. The doctor-user may respond in a custom text field response before question is resubmitted by patient and payment processed 148.

The application software documents the accessed question and assigns a time and date stamp to the transaction's reference number. The doctor-user should strive to compose an answer 152 to the patient-user's question 154 in a timely fashion and within the posted doctor-user's QRT frame 150. The application software also documents the receipt of an answer and assigns a transaction reference number in addition to time and date stamping. When the doctor-user submits the answer to the system's platform, the website may process the transaction payment from the patient-user 156.

The website may allow a method for the patient-user to interact, edit, and refine his question and, based on the discretion of the doctor-user, before the payment may be processed 156. This allows flexibility in the question and answer interaction and improved satisfaction for both users.

The patient-user may securely reestablish an e-connection to the website 158 and may have the ability to access the answer from his doctor-user in a HIPAA-compliant manner 158. The website may monitor the “e-Connect Now” availability status of the patient-user for availability to participate in enhanced, “on-demand” e-connection optional communication modes 150. The website may automatically log with a time and date stamp the patient-user accessing the content of the response from the doctor-user. Lastly, the website may log the completion of the question and answer dialogue and store the encrypted data with a reference number for access by patient-user(s) and doctor-users for a period of time 160.

Throughout the e-connection of both users (patient-user and doctor-user), the website may monitor both users' posted availability status (actively and/or passively) and allow for facilitating optional “e-Connect Now” services for “on-demand” additional e-consult communication options via industry-standard, electronic communication formats: live chat and/or audio-video teleconferencing, for example.

During the e-connected dialog, the website may monitor the status of both users (patient-user and doctor-user) and monitor both users' posted availability (both actively and passively) status. The availability status may be made known to other users with an established e-relationship. Knowing users' “e-Connect Now” availability status may allow the website to offer optional “on-demand” additional e-consult communication options via industry-standard, electronic communication formats.

Individual doctor-user and patient-user availability status or presence may be monitored actively and passively. In an active status, a doctor-user may indicate his availability to the website and that the individual doctor-user may be available and willing to be contacted by their known, established patient-user(s) and, vice versa, if the doctor-user desires to initiate contact. Additionally, the type of communication mode (text, audio, or audio-video, etc.) may be indicated by which the doctor-user or patient-user may be contacted.

For example, the individual doctor-user's internet connectivity device periodically provides an indication of the doctor-user status regarding their availability (e.g., available, online, idle, busy, for example) to the website and a communication mode (e.g., text, audio, or audio-video, etc.) by which the doctor-user or patient-user may be engaged during an e-connection e-consult. In an example of passive status monitoring, the website presumes that the doctor-user (or patient-user) may be available by the doctor-user's (or patient-user's) current status being connected to the website. Furthermore, the website indicates the passive availability status of the doctor-user (or patient-user) until the doctor-user (or patient-user) logs off the secure e-connection, except when the doctor-user may be actively participating in an e-consult with another patient-user (or doctor-user).

The website may prompt the doctor-user during registration to establish a reasonable estimate of what their typical question response time-frame would be to their patient-users in which they have an established e-relationship. Doctor-users may adjust their posted QRT status based on their capacity and free-time availability. The doctor-user may avail themselves of an website-automated “QRT reminder” system to prompt them via SMS text-messages, custom software resident on user's internet connectivity device, and/or email reminders to complete their unfinished answers for their patient-users.

The website may prompt the doctor-user during registration to set their “Do Not Disturb” hours. As discussed in the background, no individual human doctor-user may be available 24/7/365 for his patient-users and serve their needs continuously and “on demand.” In order to accommodate an individual doctor-user's desire for an undisturbed time-frame (for example: their personal sleep time), the website may allow them to post their “Do Not Disturb” time-frames and the website may not communicate with the doctor-user during that time-frame. A patient-user may have the option to submit a question during the “Do Not Disturb” time-frames of their preferred doctor-user, but the website may hold notification of a pending question until the doctor-user's “Do Not Disturb” time-frames have expired (for example: when doctor-user may be unavailable and/or unreachable on personal leave, etc.). The doctor-user, or other established and registered doctor-user colleagues within a common practice or community, may also provide a code to one or more selected patient-users to allow communication during a “Do Not Disturb” time-frame. A code may be unique to an individual patient-user and may have an expiration date associated with the code.

An individual patient-user(s) may securely login (e-connect) to the website. The patient-user should be registered and have an e-connection relationship (e-relationship) confirmed by both the patient-user and his respective doctor-user before the patient-user may initiate an e-consult question/interaction with his known doctor-user. The patient-user may reference the website's posting of his doctor-user's three status modes, QRT status, “e-Connect Now” availability status, and “Do Not Disturb” status, for example, prior to submitting a question and in accordance with his individual self-determined concern about his healthcare need's urgency. If his doctor-user's posted statuses meet the patient-user's desires, the patient-user may initiate a question.

For remunerated e-consults, individual patient-user(s) should register, have a mutually-confirmed e-connection relationship with their respective doctor-user, and have a validated an electronic payment method (e.g., PayPal, Amazon, Google Checkout, credit card, etc.) stored with the website to process transactions. Individual doctor-users should have a validated registration and have an established electronic payment receipt method (e.g., PayPal, Amazon, Google Checkout, credit card, etc.) stored with the website to process transactions. The website may process electronic payments for e-consults through the industry-standard third party electronic payment service.

The patient-user may agree in advance, in exchange for access to submit his desired question to be previewed and answered by his desired doctor-user, to permit the website to process the payment of the cost of an individual e-consult with his doctor-user. Upon completion of the doctor-user's submitted answer to the website, the payment for the e-consult service may be processed before patient-user may be granted access to the answer to his question. The doctor-user may receive his e-consult remuneration after the electronic payment has been received by the website and in accordance to the agreement terms of doctor-user and the website service. The same process may apply for the pre-paid plan for multiple e-consults with an individual doctor-user.

At some point, a doctor-user may desire to initiate a specific or general communication directive(s) to any or all his established patient-user(s) for enhanced communication efficiency to enhance their relationship via the e-connection communications system. The website may facilitate the distribution of a transactional singular or multiple communication directive(s) from a specific doctor-user and their established, e-connected patient-user(s). The common communication information data may be sent from the doctor-user to one or many or all user-patients. The communication information may be securely entered to the website via a written and readable typed text format or an uploaded audio or audio-video file format for distribution. The doctor-user may remunerate the website service in accordance to set fees in exchange for non-specific, HIPAA-compliant general communication directions communicated to all his/her established patient-users.

The doctor-user may have the option to initiate a specific e-connect communication type (text, audio, or audio-video, etc.) toward a specific patient-user in accordance to predetermined remunerated fees by the website service paid by the doctor-user. This opportunity for communication from the doctor-user to their respective patient-users allows for pushing communication directives to enhance mass communication needs and offer significant efficiencies for both users.

The website may allow an individual patient-user(s) to opt-in/opt-out to share the content of their text-typed question(s). By allowing access to the content, the patient-user may receive a lowered cost structure for the e-consult transaction by allowing the website to glean keywords from their text typed question(s). The website may allow, in accordance to their stated privacy policy, marketplace vendors of products that pertain to keywords to be advertised on the website in real-time. The right to auxiliary services may be reserved for marketing efforts with patient-user and doctor-user database information in accordance with stated website privacy policy.

The website may allow individual users, both doctor-user(s) and patient-user(s), free access to their question and answer e-connection dialog for a 30-day period starting with the completion and storage of the doctor-user's answer on the website. The content should be received and acted upon by both users as an extension to the normal daytime hours' communication between a doctor and an established patient in an established doctor-patient relationship. The content of e-connection may be available for either user to copy, print, or duplicate for their individual records. The website service may be not responsible for the content of the users and instead may be just a computerized communications system.

The purpose of the e-connection relationship may be not to replace an established doctor-patient's medical record or office-based medical home (paper or electronic version), but instead to be complementary. In this regard, the website may allow access beyond the 30-day free access period, but not longer than 90-days, in accordance to set remunerated fees by the website service. After the 90-days have expired, the website service may delete the stored data permanently in accordance to terms of website service.

By way of example, patient-user A registers with the website and creates an e-relationship with their previously established doctor-user B, also similarly registered. After both mutually confirm their e-relationship, Patient-user A submits a typed text question to website. Doctor-user B may be notified, securely e-connect to the website, and agree to e-consult. Doctor-user B may answer the question responding in optional textual, auditory (uploaded audio files, online voice communications), visual (uploaded photos and/or video and/or online video conferencing) or a combination of the modes. Patient-user A may be notified, securely e-connect to the website, and access (read) the answer. The website's application software may maintain audit logs containing time and date stamps relevant of every step in the e-connection communication interaction that may be managed via the software service.

In another example, Doctor B desires to send a general communication directive to all his patient-users in which he may have established e-relationships through the website's service. Doctor B wants to provide a non-specific, HIPAA-compliant general directive to all his patient-users about a recent FDA announcement concerning his diabetic patients on medication XYZ that may be under public scrutiny regarding its safety. To facilitate efficient communication with his registered patients, Doctor B may send the following message: “All patients taking medication XYZ, please contact my office for an appointment to discuss options and your concerns about recent announcements regarding this medication. Please do not stop your medication before talking with me individually about your specific circumstances.” The website's application software may send a general communication blast to all Doctor B's patients and issues a report (for example): “Doctor B . . . 99% of your patients have received your message re: medication XYZ and only Ms. Jones has not e-connected and accessed (read) your directive sent 7 days ago.” Alternatively, the website's application software may send a general communication blast to only Doctor B's patients who are taking medication XYZ.

It is to be understood that while certain forms of this invention have been illustrated and described, it is not limited thereto, except in so far as such limitations are included in the following claims and allowable equivalents thereof.

1. A computer-implemented medical consultation method for secure electronic communications between a doctor-user and a patient-user having a preexisting doctor-patient relationship, said method comprising:
initiating an electronic connection with a central computer by said patient-user;
prompting said patient-user to enter information;
collecting and recording said patient-user entered information on said central computer;
creating a unique identifier for said patient-user;
registering said patient-user on said central computer;
initiating an electronic connection with said central computer by said doctor-user;
prompting said doctor-user to enter information;
collecting and recording said doctor-user entered information on said central computer;
creating a unique identifier for said doctor-user;
registering said doctor-user on said central computer;
collecting and recording medical record information for said patient-user from said doctor-user on said central computer;
creating an electronic relationship between said doctor-user and said patient-user;
validating said electronic relationship created between said doctor-user and said patient-user;
if said validating step is true, then performing the following:
opening an electronic connection between said doctor-user, said patient-user and said central computer;
enabling said electronic communication by transferring question data from said patient-user to said doctor-user through said central computer and transferring answer data from said doctor-user to said patient-user through said central computer; and
storing said transferred question data and said transferred answer on said central computer.

2. The method of claim 1 wherein said registering said patient-user step further comprises said patient-user establishing an electronic payment method on said central computer and verifying said electronic payment method.

3. The method of claim 1 wherein said registering said doctor-user step further comprises said patient-user establishing individual doctor-user credentials on said central computer and verifying said individual doctor-user credentials.

4. The method of claim 1 wherein said question data includes an electronic consultation question or plurality of questions regarding self-determined personal healthcare needs and a request for a reply from their known, established doctor-user for personalized consultative advice.

5. The method of claim 4 further comprising notifying said doctor-user that question data has been submitted by said patient-user, has been stored on said central computer, and is available to be viewed by said doctor-user using a first personal internet connectivity device via a secure electronic connection with said central computer.

6. The method of claim 5 further comprising notifying said patient-user that answer data has been submitted by said doctor-user, has been stored on said central computer, and is available to be viewed by said patient-user using a second personal internet connectivity device via a secure e-connection with said central computer.

7. The method of claim 6 further comprising said central computer processing an electronic payment from said patient-user to said doctor-user via a secure electronic payment process.

8. The method of claim 1 wherein said registering said doctor-user step further comprises establishing at least one status mode for said doctor-user.

9. The method of claim 8 further comprising providing said status mode to said patient-user upon transfer of said question data.

10. The method of claim 8 wherein said at least one status mode includes a question response time frame.

11. The method of claim 10 wherein said question response time frame is selected from the group comprising within 1-4 hours, within 4-12 hours, within 12-24 hours, within 1-3 days, within 4-7 days, within 1-2 weeks, and unavailable until further notice.

12. The method of claim 8 wherein said at least one status mode includes an electronic connect now availability status.

13. The method of claim 8 wherein said at least one status mode includes a do not disturb status.

14. The method of claim 13 wherein said do not disturb status includes a predetermined time period.

15. The method of claim 14 wherein said predetermined time period is recurring.

16. The method of claim 1 wherein said answer data includes an answer-question data from said doctor-user to said patient-user.

17. The method of claim 16 further comprising a revised-question data from said patient-user to said doctor-user in response to said answer-question data from said doctor-user.

18. The method of claim 1 wherein said stored question data and said stored answer data includes a time and date stamp.

19. The method of claim 1 wherein said stored question data and said stored answer data is accessible by said patient-user and said doctor-user for a predetermined period of time.

20. The method of claim 1 wherein said patient-user includes a plurality of patient-users each having an electronic relationship with said doctor-user.

21. The method of claim 1 wherein said patient-user includes a plurality of patient-users and said doctor-user includes a plurality of doctor-users, and wherein each of said patient-users has an electronic relationship with one or more of said plurality of doctor-users, and wherein each of said doctor-users has an electronic relationship with one or more of said plurality of patient-users.

22. The method of claim 21 further comprising the step of communicating common information data from one of said doctor-users to one or more of said patient-users.
